(19) United States
(12) Patent Application Publication
(10) Pub. No.: US 2026/0179485 A1
(43) Pub. Date: Jun. 25, 2026

(54) SERVER, SYSTEM, AND METHOD FOR PROVIDING WEATHER INFORMATION

(71) Applicants: HYUNDAI MOTOR COMPANY, Seoul (KR); KIA CORPORATION, Seoul (KR)

(72) Inventors: In Tae Seo, Hwaseong-si (KR); Ji Yun Choe, Hwaseong-si (KR); Hye Won You, Hwaseong-si (KR); Dae Bong An, Hwaseong-si (KR)

(73) Assignees: HYUNDAI MOTOR COMPANY, Seoul (KR); KIA CORPORATION, Seoul (KR)

(21) Appl. No.: 19/296,528

(22) Filed: Aug. 11, 2025

(30) Foreign Application Priority Data
Dec. 24, 2024 (KR) 10-2024-0195721

(51) Int. Cl. G08G 1/0967; G01W 1/10; G06V 20/52

(52) U.S. Cl. CPC G08G 1/096775; G01W 1/10; G06V 20/52; G01W 2203/00

(57) ABSTRACT

A server, a system, and a method for providing accurate weather information by comprehensively reflecting data collected through various routes are capable of generating integrated data by integrating weather-related data collected through various routes per area, evaluating a reliability with respect to each of a plurality of weather data provision servers based on the integrated data corresponding to location information of a first vehicle requesting the weather information, determining a weather data provision server to be used for a service based on an evaluation value, and providing the weather information to the first vehicle based on the weather-related data collected from the determined weather data provision server.

### CROSS REFERENCE TO RELATED APPLICATION

The present application is based on and claims the benefit of and priority to Korean Patent Application No. 10-2024-0195721, filed on Dec. 24, 2024, in the Korean Intellectual Property Office, the entire contents of which are incorporated herein for all purposes by this reference.

### TECHNICAL FIELD

The present disclosure relates to a technology for providing weather information and, more specifically, to a server, a system, and a method for providing accurate weather information by comprehensively reflecting data collected through various routes.

### BACKGROUND

Recently, vehicles have been implemented to provide various services based on communication with servers connected through communication networks, and these vehicles may be referred to as connected cars, smart vehicles, intelligent vehicles, and the like.

One example of a service provided in a connected car environment (a connected car service), is a service that provides weather information to vehicles.

Weather information is provided in such a way that a connected car server provides raw weather data provided from a single weather data provider (hereinafter, referred to as a CP company) to the vehicle.

This method of providing weather information has a strong dependence on the CP company, so, when the CP company provides inaccurate data due to errors in sensors of an observation station, statistical errors, network errors, and the like, incorrect weather information could be provided to service users.

In addition, because the connected car server provides a one-way service that utilizes raw data from a specific CP company, it is difficult to determine the accuracy of the current weather and forecasts.

Therefore, there is a need for a method capable of providing more accurate weather information to service users.

The matters described as background technology above are only intended to enhance understanding of the background of the present disclosure, and should not be taken as acknowledging that it corresponds to the prior art already known to those having ordinary skill in the art.

### SUMMARY

A technical aspect or task of an embodiment disclosed in the present disclosure is to provide a server, a system, and a method for providing accurate weather information by comprehensively reflecting data collected through various routes.

A technical aspect or task of an embodiment of the present disclosure is to provide a server, a system, and a method for providing accurate weather information by collecting observed weather data from a plurality of weather data providers, collecting sensor data from a vehicle, and comprehensively reflecting the observed weather data and sensor data.

A technical aspect or task of an embodiment of the present disclosure is to provide a server, a system, and a method for providing weather information based on the observed weather data most similar to statistics of sensor data collected from a vehicle among observed weather data provided from a plurality of weather data providers.

The technical aspects and tasks to be achieved by the present disclosure are not limited to the technical aspects or tasks mentioned above, and other technical aspects and tasks not mentioned should be clearly understood by those having ordinary skill in the art to which the present disclosure pertains from the following description.

A server according to an embodiment of the present disclosure for achieving the objectives is capable of generating integrated data by integrating weather-related data collected through a plurality of routes per area, evaluating a reliability with respect to each of a plurality of weather data provision servers based on the integrated data corresponding to location information of a first vehicle requesting the weather information, determining a weather data provision server to be used for a service based on an evaluation value, and providing the weather information to the first vehicle based on the weather-related data collected from the determined weather data provision server.

According to an embodiment of the present disclosure, the integrated data may include observed weather data collected from the plurality of weather data provision servers, vehicle sensor data collected from a plurality of second vehicles, and statistical data on the vehicle sensor data.

According to an embodiment of the present disclosure, the server may generate the statistical data by calculating an average per parameter of a plurality of vehicle sensor data classified per area.

According to an embodiment of the present disclosure, the integrated data may further include image data collected from a road surveillance camera.

According to an embodiment of the present disclosure, the server may evaluate an accuracy of current weather information, an accuracy of weather forecast, and a reliability of the current weather information, with respect to each of the plurality of weather data provision servers.

According to an embodiment of the present disclosure, the server may determine a weather data provision server to be used for the service based on a first evaluation value based on the accuracy of the current weather information, a second evaluation value based on the accuracy of the weather forecast, and a third evaluation value based on the reliability of the current weather information.

According to an embodiment of the present disclosure, the server may select the first evaluation value, the second evaluation value, and the third evaluation value according to a type of weather information to be provided, and determine as the weather data provision server to be used for the service the weather data provision server where a sum of the selected evaluation values is the largest.

According to an embodiment of the present disclosure, the type of the weather information may include at least one of the current weather information, a weather forecast per time, and a weather forecast per day.

According to an embodiment of the present disclosure, the observed weather data may include current weather data, and the server may evaluate an accuracy of current weather information per weather data provision server based on a result of comparing the current weather data and the statistical data.

According to an embodiment of the present disclosure, the server may calculate an absolute error between a plurality of parameter values of the statistical data and a plurality of parameter values of the corresponding current weather data per weather data provision server, may calculate a weight by taking a reciprocal of the error, and may calculate an evaluation value based on the current weather information by averaging the weight calculated for each of the plurality of parameters.

According to an embodiment of the present disclosure, the observed weather data may include current weather data and weather forecast data related to the current weather data, and the server may evaluate an accuracy of a weather forecast per weather data provision server based on a result of comparing the current weather data with the weather forecast data.

According to an embodiment of the present disclosure, the server may calculate an absolute error between a plurality of parameter values of the current weather data and a plurality of parameter values of the corresponding weather forecast data per weather data provision server, may calculate a weight by taking a reciprocal of the error, and may calculate an evaluation value based on the weather forecast by averaging the weight calculated for each of the plurality of parameters.

According to an embodiment of the present disclosure, the observed weather data may include observation point data, and the server may evaluate a reliability of current weather information per weather data provision server based on the observation point data.

According to an embodiment of the present disclosure, the observation point data may include location data of an observation point, and the server may evaluate the reliability of a location of the observation point per weather data provision server based on the location data of the observation point and the location information of the first vehicle.

According to an embodiment of the present disclosure, the server may calculate a distance between the observation point and the first vehicle based on the location data of the observation point and the location data of the first vehicle, per weather data provision server, may calculate a weight by taking a reciprocal of the calculated distance, and may calculate an evaluation value based on the location of the observation point by averaging the weight calculated for each of a plurality of observation points.

According to an embodiment of the present disclosure, the observation point data may include data on a number of the observation points, and the server may evaluate a reliability of the number of the observation points per weather data provision server based on the data on the number of the observation points, where the number of the observation points can be calculated as an evaluation value for the number of the observation points.

A system for providing weather information according to an embodiment of the present disclosure includes a plurality of weather data provision servers for providing weather-related data, a first vehicle requesting the weather information, a plurality of second vehicles for providing the weather-related data obtained by sensors, and a server for providing the weather information. The server generates integrated data by integrating the weather-related data collected through a plurality of routes per area, evaluates a reliability with respect to each of the plurality of weather data provision servers based on the integrated data corresponding to location information of the first vehicle, determines a weather data provision server to be used for a service based on an evaluation value, and provides the weather information to the first vehicle based on the weather-related data collected from the determined weather data provision server.

According to an embodiment of the present disclosure, the plurality of weather data provision servers may be operated by weather data providers different from each other.

According to an embodiment of the present disclosure, the system for providing weather information may further include a road surveillance camera for providing image data obtained by photographing a road within a predetermined photographing area.

A method of providing weather information according to an embodiment of the present disclosure includes generating integrated data by a server by integrating weather-related data collected through a plurality of routes per area, evaluating a reliability with respect to each of a plurality of weather data provision servers by the server based on the integrated data corresponding to location information of a first vehicle requesting the weather information, determining a weather data provision server to be used for a service by the server based on an evaluation value, and providing the weather information to the first vehicle by the server based on the weather-related data collected from the determined weather data provision server.

In addition to the means for solving the aspects and tasks mentioned above, specific matters according to various examples of the present disclosure are included in the following description and drawings.

According to an embodiment of the present disclosure, a server, a system, and a method for providing weather information by comprehensively reflecting data collected through various routes is provided.

According to an embodiment of the present disclosure, a server, a system, and a method for providing weather information by comprehensively reflecting observed weather data collected from a plurality of weather data providers and sensor data collected from a vehicle is provided.

According to an embodiment of the present disclosure, a server, a system, and a method for providing weather information based on the observed weather data most similar to statistics of sensor data collected from a vehicle among observed weather data provided from a plurality of weather data providers is provided.

A weather information provision service implemented according to an embodiment of the present disclosure may be capable of providing accurate and reliable weather information to service users not because it is a one-way service of transmitting raw weather data of a specific weather data provider, but because weather information is provided based on evaluations of weather data providers based on data collected through various routes.

In addition, a weather information provision service implemented according to an embodiment of the present disclosure may be capable of providing the most accurate and reliable weather information to service users because weather information can be provided by reflecting location information of a vehicle.

A weather information provision service implemented according to an embodiment of the present disclosure may be capable of reducing an error risk of weather data by appropriately utilizing data from a plurality of weather data providers according to various situations.

A weather information provision service implemented according to an embodiment of the present disclosure may be capable of stably providing a weather information provision service because data from other weather data providers can be utilized even when there is an omission or error in data from a specific weather data provider.

The effects obtainable in the present disclosure are not limited to the effects mentioned above, and other effects not mentioned should be clearly understood by those having ordinary skill in the art to which the present disclosure pertains from the following description.

### BRIEF DESCRIPTION OF THE DRAWINGS

The accompanying drawings below are intended to help understand embodiments of the present disclosure, and embodiments are provided with a detailed description. However, the technical features of the embodiments of the present disclosure are not limited to a specific drawing, and the features disclosed in each drawing may be combined with each other to form a new embodiment.

FIG. 1 illustrates an example of a system configured to implement a method for providing weather information according to an embodiment of the present disclosure.

FIG. 2 illustrates an example of a configuration of a service server according to an embodiment of the present disclosure.

FIG. 3 is a flow chart for illustrating a method for providing weather information, which is implemented by a service server according to an embodiment of the present disclosure.

### DETAILED DESCRIPTION OF THE DISCLOSURE

In describing an embodiment disclosed in the present specification, when it is determined that a detailed description of a related known technology obscures the gist of the embodiment disclosed in the present specification, the detailed description thereof has been omitted. In addition, the accompanying drawings may be only intended to facilitate easy understanding of the embodiments disclosed in the present specification, and the technical idea disclosed in the present specification is not limited by the accompanying drawings, and should be understood to include all modifications, equivalents, and substitutes included in the idea and technical scope of the present disclosure.

Terms including ordinal numbers, such as a first and a second, may be used to describe various components, but the components are not limited by the terms. The terms may be used only for the purpose of distinguishing one component from another component.

Singular expressions may include plural expressions unless the context clearly indicates otherwise.

In the present specification, terms such as “comprise”, “include” or “have” may be intended to specify the existence of features, numbers, steps, operations, components, parts, or combinations thereof described in the specification, and should be understood not to exclude in advance the possibility of the presence or addition of one or more other features, numbers, steps, operations, components, parts or combinations thereof.

The suffixes “module” and “unit” for components used in the following description may be given or used interchangeably for the convenience of writing the present specification, and do not have distinct meanings or roles by themselves. In addition, the term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof. When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

When it is mentioned that a component is “connected” or “linked” to another component, it should be understood that another component may exist in the middle, although it may be directly connected to or linked to that other component. On the other hand, when it is mentioned that a component is “directly connected” or “directly linked” to another component, it should be understood that no other component exists in the middle.

Hereinafter, an embodiment disclosed in the present specification is described in detail with reference to the accompanying drawings, but the same or similar components are given the same reference numbers regardless of the drawing symbols, and redundant descriptions thereof will be omitted.

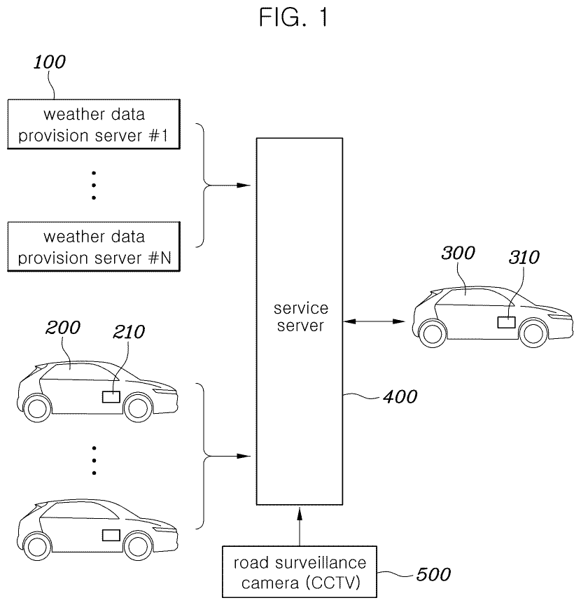

FIG. 1 illustrates an example of a system configured to implement a method for providing weather information according to an embodiment of the present disclosure.

Referring to FIG. 1, a system (hereinafter, referred to as a system for providing weather information) configured to implement a method for providing weather information according to an embodiment of the present disclosure may include a plurality of weather data provision servers 100, a first vehicle 200, a second vehicle 300, and a service server 400, but the configuration of the system is not limited thereto.

According to an embodiment, the system for providing weather information may further include a road surveillance camera 500. The road surveillance camera 500 may provide road image data obtained by photographing a road within a predetermined photographing area to the service server 400 according to a request from the service server 400. For example, the road surveillance camera 500 may be a closed-circuit television (CCTV).

The weather data provision server 100 may be a server managed and operated by a weather data provider, and a plurality of weather data provision servers 100 may be managed and operated by weather data providers different from each other.

For example, the weather data provision server 100 may receive weather data collected by at least one piece or assembly of weather observation equipment installed in a plurality of weather observation stations managed and operated by weather data providers, may integrate weather data per weather observation station, and generate, store, and provide observed weather data.

For example, the observed weather data may include current weather data and weather forecast data predicted based on the weather data.

For example, the weather data providers may include Kweather, Weather News, The Weather Channel, AccuWeather, and the Korea Meteorological Administration.

According to an embodiment, the weather data provision server 100 may include observation point data in the observed weather data and provide the same to the service server 400. For example, the observation point data may include the number of observation points and the location data of the observation points.

The first vehicle (or information provision vehicle) 200 may be subscribed to the connected car service and may communicate with the service server 400 in the connected car environment.

A vehicle terminal 210 (hereinafter, referred to as a first vehicle terminal) implemented to communicate with the service server 400 and use the connected car service may be mounted in the first vehicle 200.

For example, the first vehicle terminal 210 may implement an in-vehicle infotainment (IVI) system in the first vehicle 200.

According to an embodiment, the first vehicle terminal 210 may provide data (hereinafter, sensor data) collected from sensors in the first vehicle 200 to the service server 400 according to the request of the service server 400.

For example, the sensor data may include vehicle location data collected from a global positioning system (GPS) sensor, vehicle indoor temperature data collected from a vehicle indoor temperature sensor, vehicle outdoor temperature data collected from a vehicle outdoor temperature sensor, image data (camera image data) collected from a vehicle camera, wheel rotation data collected from a sensor (ABS sensor) of an anti-lock braking system, rain intensity/amount data collected from a rain sensor, fine dust concentration data collected from a fine dust sensor, and the like. The type of sensor data is not limited thereto, and the sensor data may include various types of weather-related data (weather-related vehicle sensor data).

The second vehicle 300 may be subscribed to the connected car service and may communicate with the service server 400 in the connected car environment.

A vehicle terminal 310 (hereinafter, referred to as a second vehicle terminal) implemented to communicate with the service server 400 and use the connected car service may be mounted in the second vehicle 300.

For example, the second vehicle terminal 310 may implement an in-vehicle infotainment (IVI) system in the second vehicle 300.

According to an embodiment, the second vehicle terminal 310 may request weather information from the service server 400 and receive weather information in response to the request.

For example, the second vehicle terminal 310 may provide vehicle location data to the service server 400 when requesting weather information. In this way, when the second vehicle terminal 310 provides the vehicle location data to the service server 400, more accurate weather information may be provided from the service server 400.

For example, the second vehicle terminal 310 may provide sensor data to the service server 400 when requesting weather information. In this way, when the second vehicle terminal 310 provides sensor data to the service server 400, more accurate weather information may be provided from the service server 400.

For example, the vehicle terminals 210 and 310 may communicate with the service server 400 based on a predetermined communication network. For example, the communication network may use wireless Internet technologies such as WLAN (Wireless LAN) (Wi-Fi), Wibro (Wireless broadband), and/or WiMax (World Interoperability for Microwave Access), and/or mobile communication technologies such as CDMA (Code Division Multiple Access), GSM (Global System for Mobile communication), LTE (Long Term Evolution), LTE-Advanced, and/or IMT (International Mobile Telecommunication)-2020.

For example, the vehicle terminals 210 and 310 may include at least one communication module, user interface, memory, processor, and the like, and the configuration of the vehicle terminals 210 and 310 is not limited thereto.

For example, a communication terminal may include a communication circuit implemented to communicate with the service server 400 through the communication network. For example, the user interface may be implemented to receive a user's input. For example, the user interface may output a graphic user interface (GUI). For example, the user interface may output a user setting menu (USM). For example, the user interface may include devices for outputting various types of information. For example, the user interface may include a speaker, a display device, and the like.

For example, the memory may store algorithms (or programs or software or apps) for performing operations of the vehicle terminals 210 and 310, data necessary for operations, and the like. For example, the memory may be implemented as at least one of storage media (or recording media) such as flash memory, hard disks, secure digital cards (SD card), random access memory (RAM), static random access memory (SRAM), read-only memory (ROM), programmable read-only memory (PROM), electrically erasable and programmable ROM

(EEPROM), erasable and programmable ROM (EPROM), registers, removable disks, web storage, and the like.

The processor may perform overall operations of the vehicle terminals 210 and 310, and may perform operations based on algorithms/data stored in the memory. For example, the processor may be a data processing device implemented with hardware having a circuit with a physical structure for executing desired operations. For example, desired operations may include codes or instructions included in a program. For example, the data processing device implemented with hardware may include a microprocessor, a central processing unit, a processor core, a multi-core processor, a multiprocessor, an application-specific integrated circuit (ASIC), and a field programmable gate array (FPGA).

The service server 400 may provide to a vehicle of service target (i.e., the second vehicle 300) the weather information generated by comprehensively reflecting data collected through various routes.

According to an embodiment, the service server 400 may collect observed weather data from the plurality of weather data provision servers 100, may collect vehicle sensor data (including weather-related vehicle sensor data) from the plurality of first vehicles 200, and may generate weather information for a service based on the collected data.

According to an embodiment, the service server 400 may further collect road image data from the road surveillance camera 500 and may further reflect the road image data to generate weather information.

According to an embodiment, the service server 400 may evaluate the accuracy of the weather forecast, the accuracy of the current weather information, and the reliability of the current weather information with respect to each of the plurality of observed weather data (i.e., the weather data provider) based on the collected data, and may generate the weather information based on the evaluation result.

According to an embodiment, the service server 400 may generate the weather information based on the observed weather data selected by reflecting location information of the vehicle of service target (i.e., the second vehicle 300) among the plurality of observed weather data.

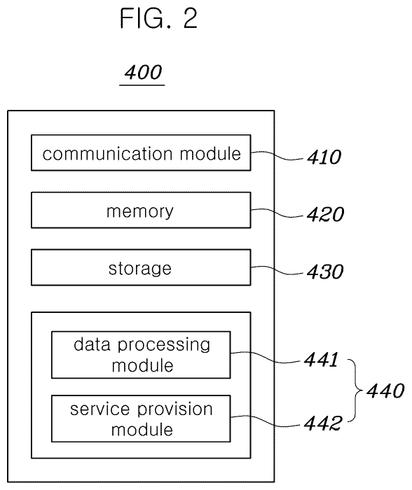

FIG. 2 illustrates an example of a configuration of a service server 400 according to an embodiment of the present disclosure.

Referring to FIG. 2, the service server 400 may be a specifically configured server and include, in one embodiment, a communication module 410, a memory 420, a storage 430, and a processor 440. However, the configuration of the service server 400 is not limited thereto.

The communication module 410 may include a communication circuit configured to communicate with the weather data provision server 100, the first vehicle 200, the second vehicle 300, and the road surveillance camera 500 through a network.

The memory 420 may store algorithms (or programs or software or computer-executable instructions) for performing the operations of the service server 400, data, and the like.

The storage 430 may store information collected or generated by the service server 400 as it operates. For example, the storage 430 may store the observed weather data collected from the weather data provision server 100, vehicle sensor data collected from the first vehicle 200, image data collected from the road surveillance camera 500, and the like. For example, the storage 430 may store various evaluation results and the weather information generated by the service server 400.

The processor 440 may perform an overall operation of the service server 400, and may provide a weather information service based on algorithms/data stored in the memory 420, information stored in the storage 430, and the like.

For example, the processor 440 may be a data processing device implemented with hardware having a circuit with a physical structure for executing desired operations (e.g., executing or performing the computer-executable instructions). For example, desired operations may include codes or instructions included in the program. For example, a data processing device implemented with hardware may include a microprocessor, a central processing unit, a processor core, a multi-core processor, a multiprocessor, an application-specific integrated circuit (ASIC), and a field programmable gate array (FPGA).

According to an embodiment, the processor 440 may include a data processing module 441 and a service provision module 442. However, the implementation example of the processor 440 is not limited thereto. For example, the service server 400 may be configured in a multi-structure, including a server for performing the function of the data processing module 441, and a server for performing the function of the service provision module 442.

The data processing module 441 may directly communicate with some of the external devices, such as the weather data provision server 100, first vehicle 200, and road surveillance camera 500, and may collect data from others of the external devices, such as the weather data provision server 100, first vehicle 200, and road surveillance camera 500.

The data processing module 441 may process the collected data and may generate information necessary for a service.

According to an embodiment, the data processing module 441 may collect the observed weather data from the plurality of weather data provision servers 100, and may classify the observed weather data per area and store the same in the storage 430.

The data processing module 441 may collect the vehicle sensor data from the plurality of first vehicles 200, and classify the vehicle sensor data per area to store the same in the storage 430.

The data processing module 441 may calculate statistical data on a plurality of vehicle sensor data classified per area, and may store the statistical data on the vehicle sensor data per area in the storage 430. For example, the data processing module 441 may calculate an average for each parameter of the plurality of vehicle sensor data classified per area, and may store the average calculated for each parameter in the storage 430 as the statistical data.

According to an embodiment, the vehicle sensor data may include various types of parameters related to weather. For example, the parameters may include weather conditions (e.g., sunny, cloudy, raining, snowing, and the like), temperature, humidity, precipitation, snowfall, wind speed, fine dust concentration, and the like, but the types of parameters are not limited thereto.

For example, weather status values, precipitation, snowfall, and the like among the parameters included in the statistical data on the vehicle sensor data may be determined based on image data collected from the first vehicle 200, wiper operation status, rain sensor values (strength, quantity), ABS sensor values, and the like, but are not limited thereto.

The data processing module 441 may collect road image data from the road surveillance camera 500, may classify the road image data per area, and store the same in the storage 430.

In this way, the data processing module 441 may integrate the observed weather data, vehicle sensor data, statistical data on the vehicle sensor data, and road image data per area and may store the same in the storage 430.

According to an embodiment, the data processing module 441 may have a separate storage device, and may store integrated data per area in a separate storage device.

The data processing module 441 may receive location information of the second vehicle 300 from the service provision module 442 and may provide the integrated data corresponding to the location information of the second vehicle 300 to the service provision module 442.

In this case, the data processing module 441 may provide the integrated data stored in the storage 430 to the service provision module 442. According to an embodiment, the data processing module 441 may provide the integrated data stored in the separate storage device to the service provision module 442.

According to an embodiment, the service provision module 442 may perform reliability evaluations for each weather data provider with respect to the corresponding area based on the integrated data per area. In other words, the service provision module 442 may perform the reliability evaluations on the observed weather data per area for each weather data provision server 100 based on the integrated data per area.

According to an embodiment, the service provision module 442 may receive a weather information provision request from the second vehicle 300. The weather information provision request may include location information of the second vehicle 300.

According to an embodiment, the service provision module 442 may perform reliability evaluations for each weather data provision server 100 based on the integrated data of the area corresponding to the location information of the second vehicle 300.

In an embodiment, the reliability evaluation may be performed in order to provide the most accurate weather information to the second vehicle 300, and the second vehicle 300 may be provided with the weather information based on the observed weather data provided from the weather data provision server 100 having the highest reliability evaluation among the plurality of weather data provision servers 100.

For example, the service provision module 442 may perform reliability evaluations for each weather data provision server 100 based on the integrated data corresponding to location information of the second vehicle 300 among the integrated data stored in the storage 430.

For example, the service provision module 442 may provide the location information of the second vehicle 300 to the data processing module 441, may receive the integrated data corresponding to the location information of the second vehicle 300 from the data processing module 441, and may perform reliability evaluations for each weather data provision server 100 based on the received integrated data.

The integrated data may include the observed weather data collected from the plurality of weather data provision servers 100, the vehicle sensor data collected from the plurality of first vehicles 200, the statistical data per parameter with respect to the plurality of vehicle sensor data, and road image data.

The observed weather data may include current weather data, weather forecast data predicting the weather at the current point in time (i.e., corresponding to the current weather data) based on previous weather data, and observation point data. Also, the observation point data may include the number of observation points and the location data of the observation points.

According to an embodiment, the service provision module 442 may evaluate the accuracy of the current weather information for each weather data provision server 100 based on the integrated data.

The service provision module 442 may evaluate the accuracy of the current weather information for each weather data provision server 100 based on a result of comparing the current weather data collected for each weather data provision server 100 and the statistical data for the vehicle sensor data.

According to an embodiment, the service provision module 442 may calculate an absolute error (|α−β|) between the parameter value (α) of the statistical data and the parameter value (β) of the corresponding current weather data, for each weather data provision server 100, and may calculate a weight (1/|α−β|) by taking a reciprocal of the error (|α−β|).

In this case, the service provision module 442 may calculate each weight with respect to a plurality of parameters.

The service provision module 442 may determine the average value of the weights calculated for each parameter as a value obtained by evaluating the accuracy of the current weather information of the corresponding weather data provision server 100.

According to an embodiment, as the error between the parameter value (α) of the statistical data and the parameter value (β) of the corresponding current weather data becomes smaller, the weight may have a larger value.

According to an embodiment, the service provision module 442 may evaluate the accuracy of the weather forecast for each weather data provision server 100 based on the integrated data.

The service provision module 442 may evaluate the accuracy of the weather forecast for each weather data provision server 100 based on a result of comparing the current weather data collected for each weather data provision server 100 with the weather forecast data corresponding to the current weather data.

According to an embodiment, the service provision module 442 may calculate an absolute error (|α−β|) between the parameter value (α) of the current weather data and the parameter value (β) of the corresponding weather forecast data for each weather data provision server 100, and may calculate a weight (1/|α−β|) by taking a reciprocal of the error (|α−β|).

In this case, the service provision module 442 may calculate each weight with respect to a plurality of parameters.

The service provision module 442 may determine the average value of the weights calculated for each parameter as a value obtained by evaluating the accuracy of the weather forecast of the corresponding weather data provision server 100.

According to an embodiment, as the error between the parameter value (α) of the current weather data and the parameter value (β) of the corresponding weather forecast data becomes smaller, the weight may have a larger value.

In summary, the service provision module 442 may determine the accuracy of the current weather information of the weather data provision server 100 and the accuracy of the weather forecast of the weather data provision server 100 based on Equations 1-4 below.

Equation 1 may be an equation for calculating the absolute error (T_{A1}) between the parameter values (α, β), Equation 2 may be an equation for calculating the weight (T′_{A1}) by taking the reciprocal of the absolute error (T_{A1}), Equation 3 may be an equation for calculating a normalized weight (WT_{A1}) for the data of the weather data provision server, and Equation 4 may be an equation for calculating the final weight (S_{A1}) of the weather data provision server, i.e., an evaluation value.

$${T}_{A 1} = \vert α - β \vert \qquad Equation 1$$

$${T}_{A 1}^{′} = \frac{1}{{T}_{A 1}} \qquad Equation 2$$

$$W {T}_{A 1} = \frac{{T}_{A 1}^{′}}{{\sum }_{i = A}^{M} {T}_{i 1}^{′}} \qquad Equation 3$$

$${S}_{A} = \frac{1}{N} {\sum }_{i = 1}^{N} W {T}_{A i} \qquad Equation 4$$

In the above equations, M is the total number of weather data provision servers, and N is the total number of parameters.

According to an embodiment, the service provision module 442 may evaluate the reliability of the current weather information based on the integrated data.

For example, the service provision module 442 may evaluate the reliability of the current weather information based on the observation point data (including the number of observation points and the location data of observation points) collected for each weather data provision server 100 and the location data of the second vehicle 300.

According to an embodiment, the reliability of the current weather information may include at least one of the reliability of the location data of the observation points or the reliability of the number of the observation points.

The service provision module 442 may calculate a distance between an observation point (or an observation station) and the second vehicle 300 based on the location data of the observation point for each weather data provision server 100 and the location data of the second vehicle 300, and may calculate a weight by taking a reciprocal of the calculated distance.

The service provision module 442 may calculate each weight for the location data of the plurality of observation points.

The distance may not be obtained by the difference between the latitude data and the longitude data, so the service provision module 442 may calculate weights for the location data of the plurality of observation points based on the distance calculation formula.

For example, the service provision module 442 may calculate the distance between the observation point and the second vehicle 300 based on the Haversine formula, and the method of calculating the distance between the observation point and the second vehicle 300 is not limited thereto.

Equation 5 below may represent a formula for calculating a distance (d) between the observation point (or an observation station) and the second vehicle 300.

$$d = 2 * r * a sin ( \sqrt{{sin}^{2} ( \frac{{lat}_{β} - {lat}_{α}}{2} ) + cos ( {lat}_{α} ) * cos ( {lat}_{β} ) * {sin}^{2} ( \frac{{lon}_{β} - {lon}_{α}}{2} )} ) \qquad Equation 5$$

In Equation 5, r is the radius of the earth, lat_{α} is the latitude data of the vehicle, long is the longitude data of the vehicle, late is the latitude data of the observation point, and long is the longitude data of the observation point.

The service provision module 442 may determine the average value of weights calculated for the location data of the plurality of observation points as a value obtained by evaluating the reliability of the location data of the observation points of the corresponding weather data provision server 100.

The service provision module 442 may determine the number of the observation points for each weather data provision server 100 as a value obtained by evaluating the reliability of the number of the observation points of the corresponding weather data provision server 100.

According to an embodiment, the service provision module 442 may provide the weather information to the second vehicle 300 based on the evaluation value for each weather data provision server 100.

For example, the service provision module 442 may provide the current weather information, a weather forecast per time, and a weather forecast per day.

According to an embodiment, the service provision module 442 may select the weather data provision server 100 based on the evaluation value according to the type of the weather information to be provided, and may provide the weather information based on the observed weather data collected from the selected weather data provision server 100.

For example, when providing the current weather information, the service provision module 442 may provide the current weather information based on the observed weather data collected from the weather data provision server 100 with the highest evaluation value of the accuracy for the current weather information.

For example, when providing the weather forecasts per time, the service provision module 442 may provide the weather forecasts per time based on the observed weather data collected from the weather data provision server 100 that has the largest value obtained by adding an evaluation value based on the accuracy of the current weather information, an evaluation value based on the accuracy of the weather forecast, and an evaluation value based on the reliability of the current weather information.

For example, when providing the weather forecast per day, the service provision module 442 may provide the weather forecast per day based on the observed weather data collected from the weather data provision server 100 that has the largest value obtained by adding an evaluation value based on the accuracy of the weather forecast and an evaluation value based on the reliability of the current weather information.

According to an embodiment, when there is an error in some values of data from the weather data provider, the service provision module 442 may not provide, in the corresponding area, the data of the weather data provider that has provided the error data.

In an embodiment of the present disclosure, the reliability evaluation may be performed based on a method of assigning weights by calculating an error between reference data and comparison data. Accordingly, a higher weight may be assigned to data with high reliability, so it may be possible to improve the accuracy and reliability of the overall data by selectively utilizing data of reliable weather data providers.

In an embodiment of the present disclosure, a weight for current weather accuracy, a weight for forecast accuracy, and a weight for the distance between the user's location and the observation station may be calculated. Therefore, the data of the weather data provider may be selected based on the weight considering different factors, so it may be possible to select the data of the weather data provider most suitable for the location and demand of the user and provide a better service.

When determining the accuracy of the current weather data, an embodiment of the present disclosure may use not only the data provided by the weather data provider but also the statistical data of various vehicles in the area where the current user vehicle is present, so it may be possible to use more accurate data than the observed data with limited locations of observation stations or a small number of observation points.

In an embodiment of the present disclosure, a weight may be calculated in consideration of the user's location, i.e., the number of observation points in an area corresponding to the vehicle location. As an area has a larger number of observation points, the weather information in the corresponding area may be more accurately figured out, so the weight may be calculated in consideration of the number of observation points per area and more accurate weather information may be provided by selecting and using the data of the weather data provider with a higher weight.

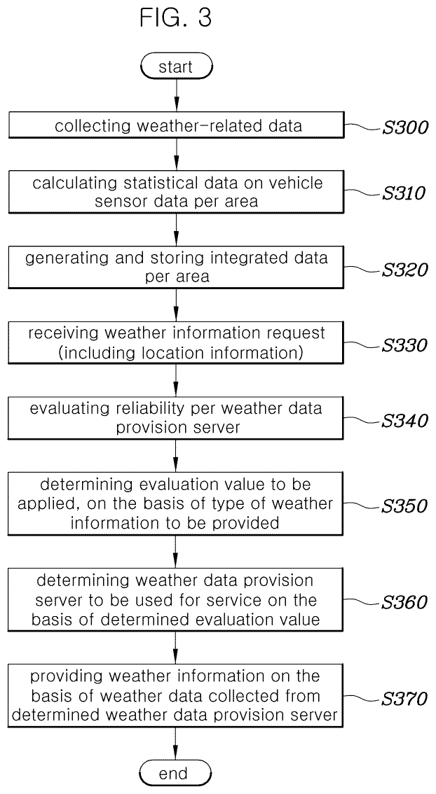

FIG. 3 is a flow chart for illustrating a method for providing weather information, which is implemented by a service server 400 according to an embodiment of the present disclosure.

Referring to FIG. 3, the service server 400 may collect weather-related data (S300).

In the step S300, the service server 400 may collect observed weather data from the plurality of weather data provision servers 100, may collect vehicle sensor data from the plurality of first vehicles 200, and may collect road image data from the road surveillance camera 500.

Thereafter, the service server 400 may calculate statistical data on the vehicle sensor data per area (S310).

In the step S310, the service server 400 may calculate an average for each parameter of the plurality of vehicle sensor data classified per area. The average calculated for each parameter may correspond to the statistical data.

The service server 400 may generate and store integrated data by integrating the observed weather data, vehicle sensor data, statistical data on the vehicle sensor data, and road image data per area (S320).

The service server 400 may store the integrated data per area in the storage 430 or a separate storage device.

The service server 400 may receive a weather information request including location information from the second vehicle 300 (S330).

According to an embodiment, the weather information request may include information on a type of the weather information to be provided. The type of the weather information may include the current weather information, the weather forecast per time, the weather forecast per day, and the like.

Thereafter, server 400 may evaluate the reliability of each weather data provision server 100 based on the integrated data corresponding to the location information of the second vehicle 300 (S340).

In the step S340, the service server 400 may evaluate the accuracy of the current weather information, the accuracy of the weather forecast, and the reliability of the current weather information per weather data provision server 100.

In the step S340, the service server 400 may generate a first evaluation value by evaluating the accuracy of the current weather information, may generate a second evaluation value by evaluating the accuracy of the weather forecast, and may generate a third evaluation value by evaluating the reliability of the current weather information.

In other words, the service server 400 may generate the first evaluation value, the second evaluation value, and the third evaluation value for each weather data provision server 100.

Thereafter, the service server 400 may determine an evaluation value to be applied, based on the type of the weather information to be provided (S350).

In the step S350, the type of the weather information to be provided may be predetermined in the service server 400. According to an embodiment, the type of the weather information to be provided may be included in the weather information request of the second vehicle 300.

For example, the type of the weather information to be provided may be the current weather information, the weather forecast per time, the weather forecast per day, and the like.

Thereafter, the service server 400 may determine the weather data provision server 100 to be used for the service based on the determined evaluation value (S360), and may provide the weather information to the second vehicle 300 based on the weather data collected from the determined weather data provision server 100 (S370).

The embodiments of the present disclosure have been described in more detail with reference to the accompanying drawings, but the present disclosure is not necessarily limited to these embodiments, and may be practiced in various modifications without departing from the technical idea of the present disclosure. Accordingly, the embodiments disclosed in the present specification are intended to illustrate and not to limit the technical ideas of the present disclosure, and the scope of the technical idea of the present disclosure is not limited by the embodiments. Therefore, it should be understood that the embodiments described above are beneficial and not limited in all respects. The protection scope of the present disclosure should be interpreted by the scope of claims, and all technical ideas within the equivalent scope should be construed as being included in the scope of the rights of the present disclosure.

What is claimed is:

1. A server configured to provide weather information to a vehicle, the server being configured to:
generate integrated data by integrating weather-related data collected through a plurality of routes per area;
evaluate a reliability with respect to each of a plurality of weather data provision servers based on the integrated data corresponding to location information of a first vehicle requesting the weather information;
determine a weather data provision server of the plurality of weather data provision servers to be used for a service based on an evaluation value; and
provide the weather information to the first vehicle based on the weather-related data collected from the determined weather data provision server.

2. The server of claim 1, wherein the integrated data comprises observed weather data collected from the plurality of weather data provision servers, vehicle sensor data collected from a plurality of second vehicles, and statistical data on the vehicle sensor data.

3. The server of claim 2, wherein the server is further configured to generate the statistical data by calculating an average per parameter of a plurality of vehicle sensor data classified per area.

4. The server of claim 2, wherein the integrated data further comprises image data collected from a road surveillance camera.

5. The server of claim 1, wherein the server is further configured to evaluate an accuracy of current weather information, an accuracy of a weather forecast, and a reliability of the current weather information, with respect to each of the plurality of weather data provision servers.

6. The server of claim 5, wherein the server is configured to determine a weather data provision server to be used for the service based on a first evaluation value based on the accuracy of the current weather information, a second evaluation value based on the accuracy of the weather forecast, and a third evaluation value based on the reliability of the current weather information.

7. The server of claim 6, wherein the server is further configured to select the first evaluation value, the second evaluation value, and the third evaluation value according to a type of the weather information to be provided, and determine as the weather data provision server to be used for the service the weather data provision server where a sum of the selected evaluation values is the largest.

8. The server of claim 7, wherein the type of the weather information comprises the current weather information, a weather forecast per time, and a weather forecast per day.

9. The server of claim 2, wherein the observed weather data comprises current weather data, and
wherein the server is further configured to evaluate an accuracy of current weather information per weather data provision server based on a result of comparing the current weather data and the statistical data.

10. The server of claim 9, wherein the server is further configured to:
calculate an absolute error between a plurality of parameter values of the statistical data and a plurality of parameter values of the corresponding current weather data, per weather data provision server;
calculate a weight by taking a reciprocal of the error; and
calculate an evaluation value based on the current weather information by averaging the weight calculated for each of the plurality of parameters.

11. The server of claim 2, wherein the observed weather data comprises current weather data and weather forecast data related to the current weather data, and
wherein the server is configured to evaluate an accuracy of a weather forecast per weather data provision server based on a result of comparing the current weather data with the weather forecast data.

12. The server of claim 11, wherein the server is further configured to:
calculate an absolute error between a plurality of parameter values of the current weather data and a plurality of parameter values of the corresponding weather forecast data, per weather data provision server;
calculate a weight by taking a reciprocal of the error; and
calculate an evaluation value based on a weather forecast by averaging the weight calculated for each of the plurality of parameters.

13. The server of claim 2, wherein the observed weather data comprises observation point data, and
wherein the server is further configured to evaluate a reliability of current weather information per weather data provision server based on the observation point data.

14. The server of claim 13, wherein the observation point data comprises location data of an observation point, and
wherein the server is further configured to evaluate a reliability of a location of the observation point per weather data provision server based on the location data of the observation point and the location information of the first vehicle.

15. The server of claim 14, wherein the server is further configured to:
calculate a distance between the observation point and the first vehicle based on the location data of the observation point and the location information of the first vehicle, per weather data provision server;
calculate a weight by taking a reciprocal of the calculated distance; and
calculate an evaluation value based on the location of the observation point by averaging the weight calculated for each of a plurality of observation points.

16. The server of claim 13, wherein the observation point data comprises data of a number of the observation points, and
wherein the server is further configured to evaluate a reliability of the number of the observation points per weather data provision server based on the data on the number of the observation points, where the number of the observation points can be calculated as an evaluation value for the number of the observation points.

17. A system configured to provide weather information, the system comprising:
a plurality of weather data provision servers configured to provide weather-related data;
a first vehicle configured to request the weather information;
a plurality of second vehicles configured to provide the weather-related data obtained by sensors; and
a server configured to provide the weather information,
wherein the server is further configured to generate integrated data by integrating the weather-related data collected through a plurality of routes per area, evaluate a reliability with respect to each of the plurality of weather data provision servers based on the integrated data corresponding to location information of the first vehicle, determine a weather data provision server of the plurality of weather data provision servers to be used for a service based on an evaluation value, and provide the weather information to the first vehicle based on the weather-related data collected from the determined weather data provision server.

18. The system of claim 17, wherein the plurality of weather data provision servers are configured to be operated by weather data providers different from each other.

19. The system of claim 17, further comprising:
a road surveillance camera configured to provide image data obtained by photographing a road within a predetermined photographing area.

20. A method of providing weather information, the method comprising:
generating, by a server, integrated data by integrating weather-related data collected through a plurality of routes per area;
evaluating, by the server, a reliability with respect to each of a plurality of weather data provision servers based on the integrated data corresponding to location information of a first vehicle requesting the weather information;
determining, by the server, a weather data provision server of the plurality of weather data provision servers to be used for a service based on an evaluation value; and
providing, by the server, the weather information to the first vehicle based on the weather-related data collected from the determined weather data provision server.
